(19) United States
(12) Patent Application Publication
(10) Pub. No.: US 2008/0251609 A1
(43) Pub. Date: Oct. 16, 2008

(54) Apparatus Used in Combination with Paint Delivery hopper

(76) Inventor: Chin-Ming TING, Taichung Hsien (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/734,333

(22) Filed: Apr. 12, 2007

(51) Int. Cl. B05B 9/00; B05B 7/30; B05B 1/00

(52) U.S. Cl. 239/379; 239/345; 239/600

(57) ABSTRACT

An apparatus is used in combination with a paint delivery hopper. The hopper includes a body and a connecting portion, with the connecting portion having a connecting end and a projection extending from the body thereof. The apparatus is used to engage with the hopper and it includes a receiving region, a through hole defined in the receiving region for allowing the connecting end to be attached thereto and an engaging hole which allows the projection to be inserted therethrough.

### BACKGROUND OF THE INVENTION

1. Field of the Invention

The present invention relates to a combination of an apparatus and a paint delivery hopper, and the apparatus and the paint delivery hopper can be easily installed therewith.

2. Description of the Related Art

Referring to Taiwan Pat. No. M278483, there discloses a structurally modified hopper B for use with a paint gun. The hopper B is a funnel-shaped container, in which paint can be filled through the wide end and dispensed through the narrow end, which an adapter 20 can be connected thereto.

Unfortunately, the hopper B has trouble to stay upright on a table when it is dismounted from the paint gun, as the hopper B is erected with the narrow end at the bottom and the wider end at the top. Furthermore, if an operator wants to stir the paint inside the hopper B, the operator has to apply one hand to hold the hopper B while with the other hand performing stirring. Therefore, it is inconvenient for the operator.

The present invention is, therefore, intended to obviate or at least alleviate the problems encountered in the prior art.

### SUMMARY OF THE INVENTION

An apparent is used in combination with a paint delivery hopper. The hopper includes a body and a connecting portion, with the connecting portion having a connecting end and a projection extending from the body thereof. The apparatus is used to engage with the hopper and it includes a receiving region, a through hole defined in the receiving region for allowing the connecting end to be attached thereto and an engaging hole which allows the projection to be inserted therethrough.

It is an objective of the present invention to provide an apparatus which allows the hopper to be stably placed on a table.

It is another objective of the present invention to provide a projection preventing the hopper from moving with respect to the apparatus when stirring the paint inside the hopper.

Other objectives, advantages, and novel features of the invention will become more apparent from the following detailed description when taken in conjunction with the accompanying drawings.

### BRIEF DESCRIPTION OF THE DRAWINGS

FIG. 1 is a side elevation view of a paint feed hopper according to the present invention in use with a paint gun.

FIG. 2 is an exploded perspective view of an apparatus used in combination with a paint delivery hopper in accordance with the first embodiment of the present invention.

FIG. 3 is a perspective view of an apparatus used in combination with a paint delivery hopper in accordance with the first embodiment of the present invention.

FIG. 4 is a cross-sectional view taken along line 4-4 of FIG. 3.

FIG. 5 is an exploded perspective view of an apparatus used in combination with a paint delivery hopper in accordance with the second embodiment of the present invention.

FIG. 6 is a cross-sectional view, similar to FIG. 4, but of the second embodiment of the present invention.

### DETAILED DESCRIPTION OF THE PREFERRED EMBODIMENT

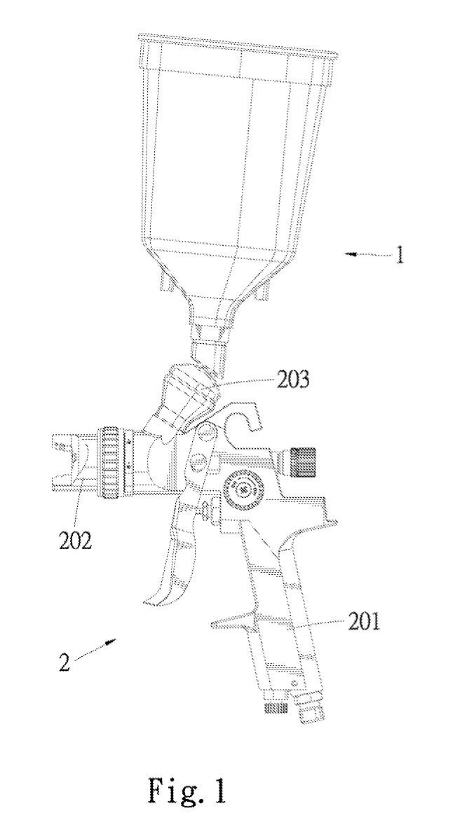

Referring to FIG. 1, a paint gun 2 in accordance with the present invention includes a handgrip 201, a spray head 202 and an adapter 203 for allowing a hopper 10 to be installed therewith.

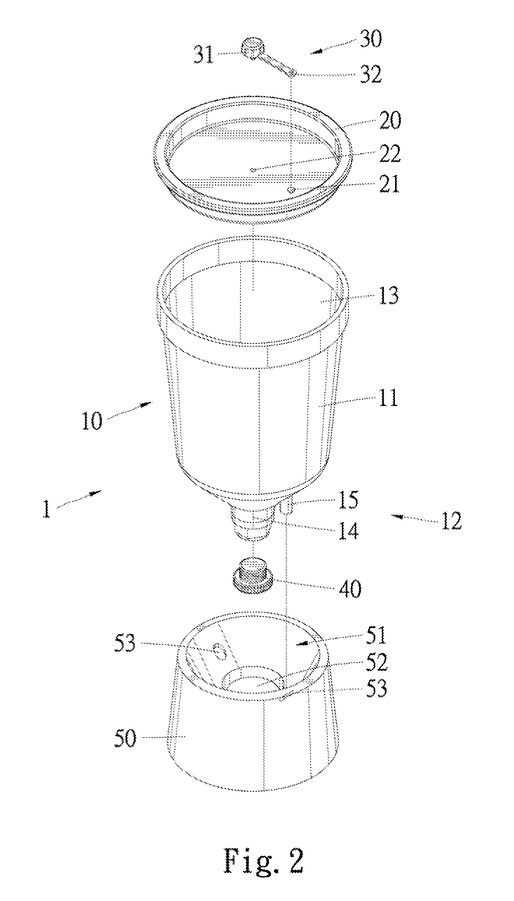

Referring to FIGS. 2 through 4, the hopper 10 includes a body 11 with a connecting portion 12 defined at one end and opening 13 at the other end. The body 11 is cylindrical in shape and gradually slopes toward the connecting portion 12 as extending downward axially from the opening 13. The connecting portion 12 includes a connecting end 14 at which two projections 15 extending downward from the body 11 are disposed at sides thereof.

A cover 20 which is complement to an opening 13 includes a knob 21 extending therefrom and an aperture 22 defined thereover. A plug 30 includes a protrusion 31 which easily shuts the aperture 22 and an attaching end 32 fixed to the knob 21 so that the plug 30 is connected to the cover 20.

A closer 40 which is provided to close the connecting end 14, so that the hopper 10 itself can confine the paint within the hopper 10.

An apparatus 50 which is used to engage the hopper 10 includes a receiving region 51, a through hole 52 defined in the receiving region 51 and two engaging holes 53 corresponding to the projections 15 so as to allow attachment thereto. The through hole 52 is adapted for the connecting end 14 to be inserted therethrough.

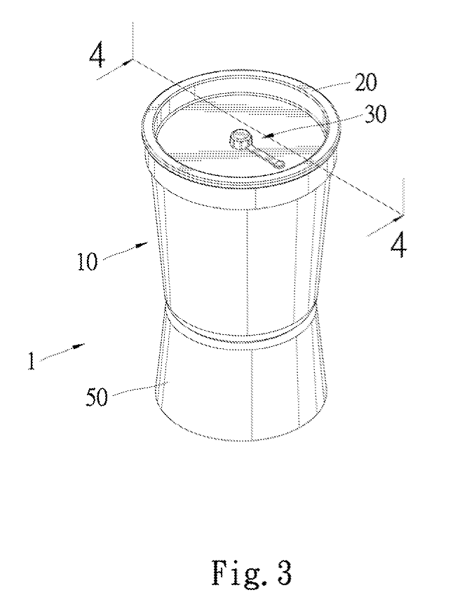

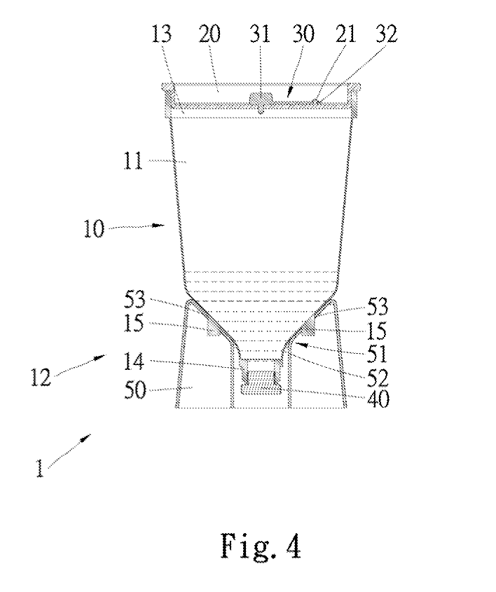

FIGS. 3 and 4 illustrate the combination of the hopper 10 and the apparatus 50, which is referred as numeral 1. The hopper 10 is joined with the apparatus 50 and stably maintained in an upright position, the projections 15 are inserted through the engaging holes 53 so that the hopper 10 will not rotate with respect to the apparatus 50 when a user tries to stir the paint inside the hopper 10.

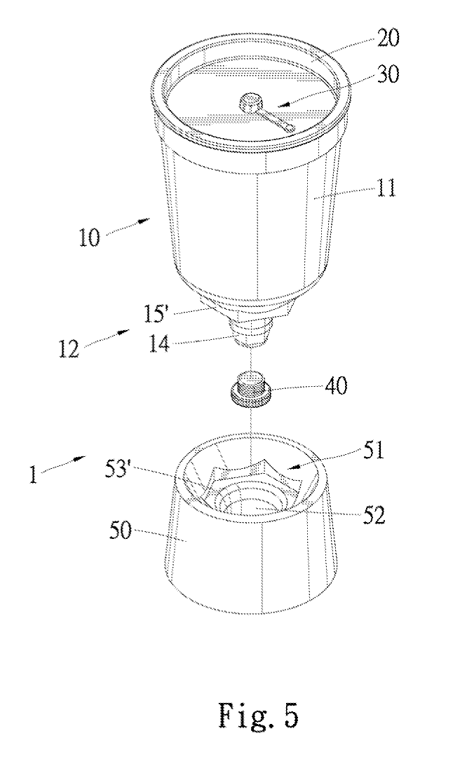

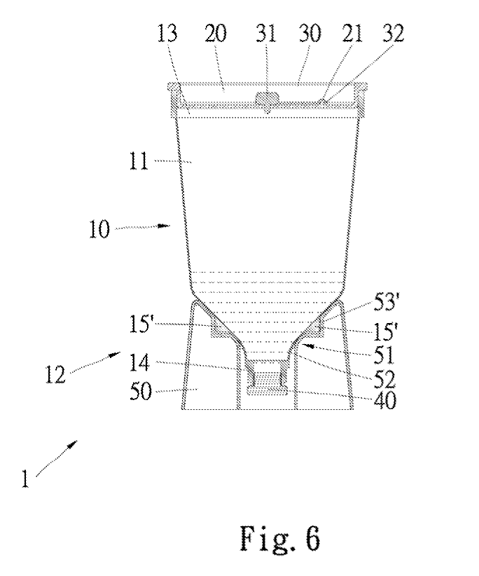

FIGS. 5 and 6 illustrate a second embodiment of the present invention. The second embodiment is similar to the first one, except that a hexagonal projection 15′ extends downward from the body 11 and the connecting end 14 projecting downward from the hexagonal projection 15′. Furthermore, the engaging hole 53′ is in a shape complement to the projection 15′ so as to allow the projection 15′ to be inserted therethrough.

In view of the foregoing, the apparatus 50 used in combination with the hopper 10 has for its objects to allow the hopper 10 to be stably placed on a table and the projection 15, 15′ serve as a means to prevent the hopper 10 from moving with respect to the apparatus 50 when an operator wants to stir the paint inside the hopper 10. Furthermore, the structure is relatively simple and of general serviceability to prevent a relative movement between the hopper 10 and the apparatus.

While the specific embodiments have been illustrated and described, numerous modifications come to mind without significantly departing from the spirit of invention and the scope of invention is only limited by the scope of accompanying claims.

What is claimed is:

1. An apparatus used in combination with a paint delivery hopper comprising:
a hopper including a body and a connecting portion and;
an apparatus including a receiving region releasably connected to the connecting portion, wherein the receiving region is provided to prevent the hopper from moving with respect to the apparatus and;
wherein the hopper is disconnected from the apparatus for paint-spraying.

2. The apparatus used in combination with the paint delivery hopper as claimed in claim 1 wherein the connecting portion includes a connecting end and a projection defined thereof, and the receiving region includes a through hole and an engaging hole defined thereof, said through hole is adapted for receiving said connecting end, said engaging hole is adapted for receiving said projection.

3. The apparatus used in combination with the paint delivery hopper as claimed in claim 2 wherein the projection is defined at the side of the connecting end, and the engaging hole is defined at the side of the through hole.

4. The apparatus used in combination with the paint delivery hopper as claimed in claim 3 wherein the connecting end includes two projections disposed at sides thereof, and the through hole includes two engaging holes disposed at sides thereof.

5. The apparatus used in combination with the paint delivery hopper as claimed in claim 2 wherein the projection and the connecting end are coaxial, the engaging hole and the through hole are coaxial, and the engaging hole is adapted for reception of the projection.

6. The apparatus used in combination with the paint delivery hopper as claimed in claim 5 wherein the projection includes a polygonal periphery defined thereof, and the engaging hole includes a polygonal periphery defined thereof.

7. The apparatus used in combination with the paint delivery hopper as claimed in claim 5 wherein the projection includes a hexagonal periphery defined thereof, the engaging hole includes a hexagonal periphery defined thereof.

8. The apparatus used in combination with the paint delivery hopper as claimed in claim 1 wherein the hopper includes an opening defined at an end thereof.

9. The apparatus used in combination with the paint delivery hopper as claimed in claim 8 wherein the opening is provided for the reception of a cover.

10. The apparatus used in combination with the paint delivery hopper as claimed in claim 9 wherein the cover includes an aperture defined thereover, a knob extending therefrom, and a plug attached thereto, the plug includes a protrusion and an attaching end, wherein the protrusion is adapted for shutting the aperture and the attaching end is adapted for connecting with the knob.

11. The apparatus used in combination with the paint delivery hopper as claimed in claim 2 wherein the connecting end includes a closer connected thereto.
